(19) United States
(12) Patent Application Publication
(10) Pub. No.: US 2011/0067262 A1
(43) Pub. Date: Mar. 24, 2011

(54) DRIENG SYSTEM WITH CIRCULATING GAS

(76) Inventor: Erma Eero, Tumba (SE)

(21) Appl. No.: 12/992,548

(22) PCT Filed: Jun. 2, 2009
(86) PCT No.: PCT/SE2009/000287

§ 371 Date: Nov. 12, 2010

(30) Foreign Application Priority Data
Jun. 4, 2008 (SE) 0801322-9

(51) Int. Cl. F26B 3/00

(52) U.S. Cl. 34/467

(57) ABSTRACT

This drying system dries material with circulating gas or steam of any type. Air is used as the name for the gas. A drying cycle consists of the following basic phases: •Charging of drying material •Heating with circulating air without discharge of air until the air before the air heater has reached desired relative humidity and temperature •Discharge of warm humid air with continued heating of circulating air and intake of outside air or returned dehumidified air. The discharged flow is so controlled that the in the dryer circulating air keeps its desired relative humidity and temperature. •Discharge of the dried material and at the same time cleaning of all the components whose function can be disturbed by dust. •Charging of new material to be dried.

### BACKGROUND

The ability of gases and steam to carry water vapor increases by the increasing temperature. The conventional driers working with heated air as drying gas through a bed discharge the vapor in the atmosphere. The air is cooled by evaporation when it is taking over evaporated water and is discharged into the atmosphere at a relatively low temperature. That type of air-dryers need large air flows for the drying and leave emissions from the dried material into the atmosphere. During the drying at low outside temperature the large airflow is heated up to the drying temperature of the dryer, which means a high energy loss.

With the device according to this innovation only a small air flow is discharged into the atmosphere in one of the alternatives. In two other alternatives no drying gas is discharged into the atmosphere and main part of the drying energy is reused.

### SYSTEM DESCRIPTION

1. Figures

| Pos. | Name |
|---|---|
| 1 | Filling plate |
| 2 | Container for filling material |
| 3 | Material for next drying cycle |
| 4 | Circulation valve |
| 5 | Inlet channel |
| 6 | Inlet valve |
| 7 | Cleaning system for the air heater |
| 8 | Circulation fan |
| 9 | Air heater |
| 10 | Outlet pipe for the heating fluid from the air heater |
| 11 | Bar feeder for the side wall for discharging the dried material |
| 12 | Mobile side wall for discharging of the dried material |
| 13 | Inlet pipe for the heating fluid to the air heater |
| 14 | Bar feeder with scraper for the drying material fallen from the |
| | 16 to the bottom |
| 15 | Outlet for cleaning water to the cleaning of condensate |
| 16 | Bottom with air openings for the drying material |
| 17 | Bottom for collecting the drying material fallen through the |
| | air holes in the 16 |
| 18 | Conveyer |
| 19 | Dried material during transportation |
| 20 | Mobile sidewall for opening of a discharge channel |
| 21 | Drying material |
| 22 | Bar feeder for the mobile side wall 20 |
| 23 | Outlet channel for the air outlet |
| 24 | Outlet valve for the air |
| 25 | Drying device |
| 26 | Air channel to the air condenser |
| 27 | Ionizator |
| 28 | Air condenser |
| 29 | Heating circuit to the preheater |
| 30 | Preheater |
| 31 | Circulation fan for dehumidified air |
| 32 | Droplet separator |
| 33 | Pump for hot water circuit from the economizer 46 |
| 34 | Pump for fluid circuit for recovering waste heat from the |
| | flue gas condenser 58 |
| 35 | Return pipe to the economizer 46 |
| 36 | Outlet of condensate to the cleaning system from the air |
| | condenser 28 |
| 37 | Pipe for delivering waste heat from the flue gas condenser 58 |
| 38 | Pipe for hot water from the economizer 46 |
| 39 | Return pipe for recovering heat from the flue gas condenser 58 |
| 40 | Pipe with regulation valve for heating of any desired object |
| | with return water from 9 |
| 41 | Desired object for heating with return water from the heater 9, |
| | e.g. footballs plane with artificial grass |
| 42 | Outlet for condensate from flue gas condenser 58 to a |
| | cleaning system |
| 43 | Combustion plant |
| 44 | Dust cleaner for flue gas |
| 45 | Flue gas channel from 43 |
| 46 | Economizer |
| 47 | Circulation pump for heat recovery from air condenser 28 |
| 48 | Receiver of heat from 28 |
| 49 | Pipe with control valve for selecting suitable heating for 48 |
| 50 | Humidity-and temperature probe |
| 51 | Air/air heat exchanger between ambient air and in the drying |
| | system circulating air |
| 52 | Outlet of condensate and cleaning water from 51 to water |
| | cleaning system |
| 53 | Circulation fan for air to be dehumidified |
| 54 | Air fan for cooling air |
| 55 | Preheater for dehumidified cooled air |
| 56 | Inlet pipe to preheater 55 |
| 57 | Outlet pipe from preheater 55 |
| 58 | Flue gas condenser |
| 59 | Cleaning device for air/air heat exchanger 51 |
| 60 | Cleaning device for air condenser 28 |
| 61 | Heat circuit between cascade dryers |
| 62 | Cascade condenser |
| 63 | Control valve for the first drying stage |
| 64 | Pipe for economizer connected to return water |
| 65 | Control valve connected to the second drying stage |
| 66 | Drying stage 2 |
| 67 | Ionizator |
| 68 | Flue gas outlet to the stack |
| 69 | Cleaning device for the flue gas condenser |
| 70 | Exchange valve |

Any type of gas or any type of steam is used as the circulating gas. Air is used as name for the gas.

### A Drying Cycle Consists of the Following Basic Phases:

Charging of drying material
Heating with circulating air without discharge of air until the air before the air heater has reached desired relative humidity and temperature
Discharge of warm humid air with continued heating of circulating air and intake of outside air or returned dehumidified air. The discharged flow is so controlled that the in the dryer circulating air keeps its desired relative humidity and temperature.
Discharge of the dried material and at the same time cleaning of all the components whose function can be disturbed by dust.
Charging of new material to be dried.

2. Central Unit

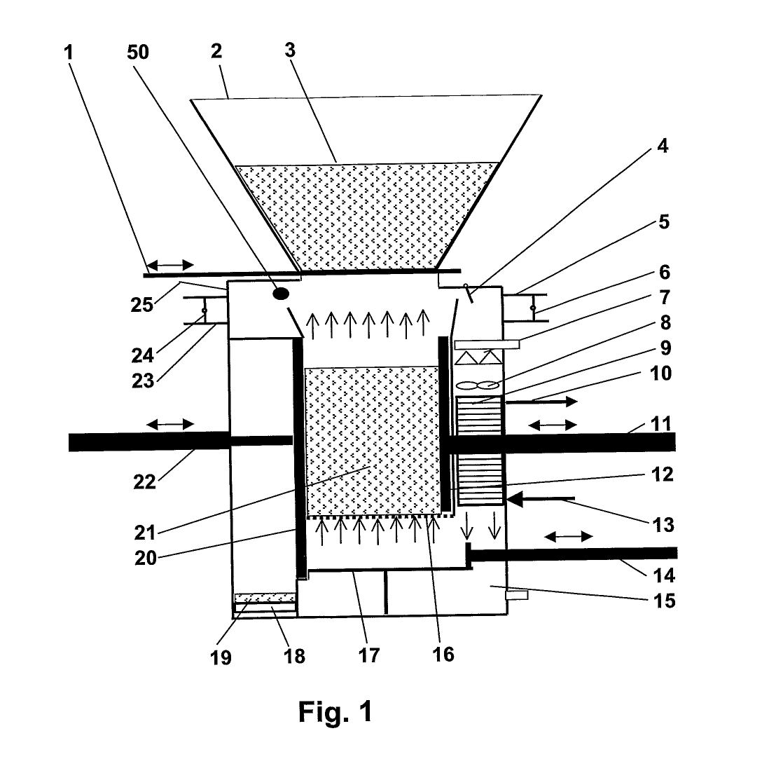

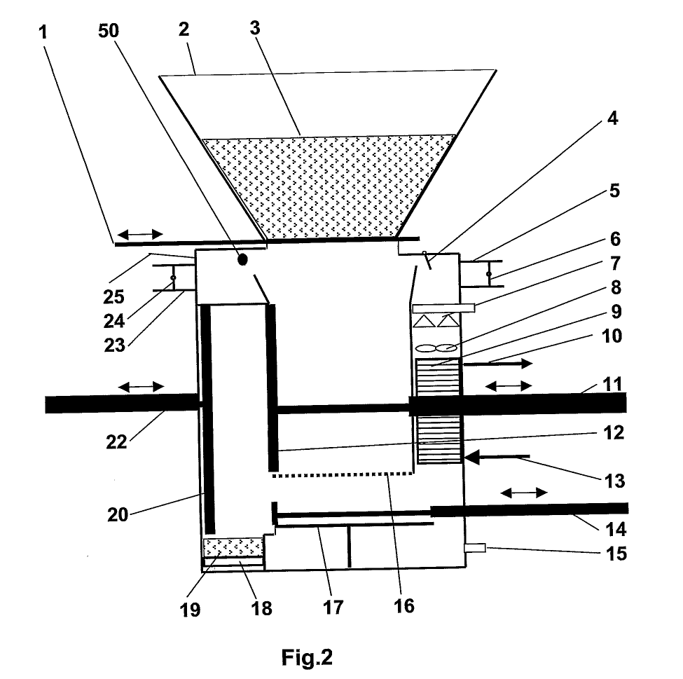

In the FIG. 1 the central unit is shown during the drying period and in the FIG. 2 when the dried material has discharged from the unit.

The drying material is in a container in the drying unit 25 whose two walls 12 and 20 are movable. The wall 12 is pending some centimeters to keep the drying material moving so that the drying air easier comes into contact with all particles. If needed some rotating agitators are pushed through one of both of the stable walls to additionally improve the agitation of the drying material. These agitators (not shown in the FIGS. 1 and 2) draws out when the container is emptied.

The bottom 16 of the container is designed to let air come through it. The fan 8 sucks air from the over half of the container. The air is heated in the heater 9 and goes again through the bottom 16 to the bed 21. No air bypasses the heater 9, all the air is heated. The dampers 6 and 24 are closed. The probe 50 is used to measure the temperature and the relative humidity of the air. The recirculation of the air continues until the relative humidity comes up to a decided value, e.g. 95% at the same time as the temperature of the air reaches a desired value e.g. 5 C under the fluid temperature which through the pipe 13 heats up the air.

When the decided values are reached in the simplest case dampers 6 and 24 are opened to let out a decided air flow which is substituted with incoming outdoor air. If waste energy is available the incoming air is heated with the waste energy in a heat exchanger before the fan 8. The probe controls the dampers. The drying goes now on with discharge of the evaporated water from the drying material until the probe closes the dampers at a decided position which has experimentally found out to give the desired humidity in the drying material, e.g. 10%.

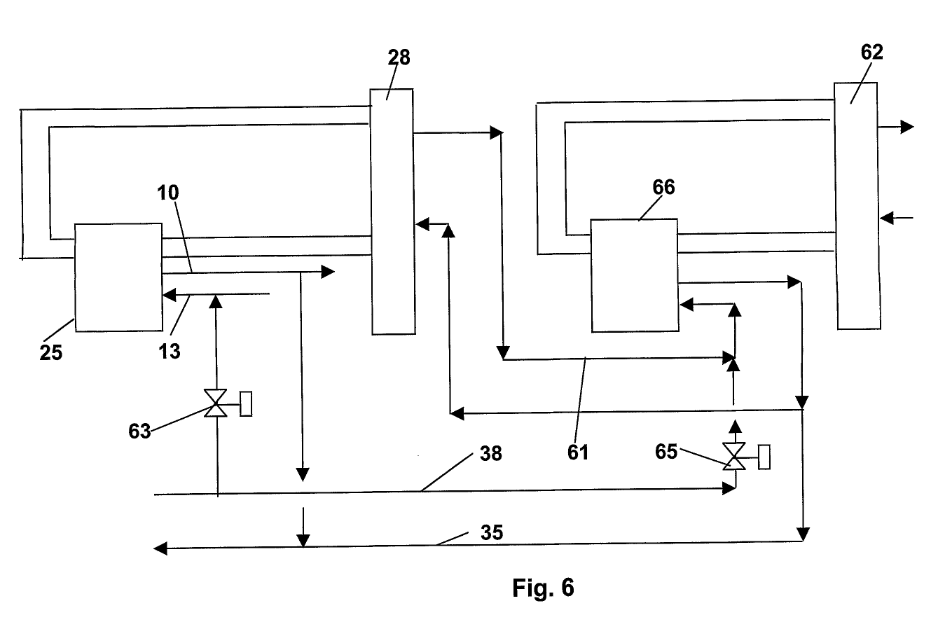

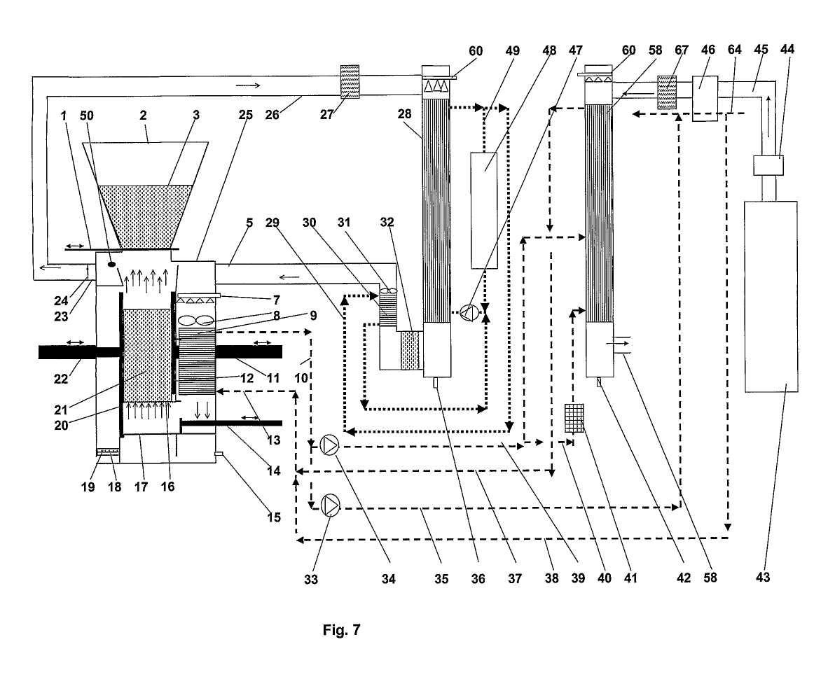

A final drying can be done by high temperature heat from e.g. the economizer 46, see FIGS. 6 and 7. The control valve 63 distributes e.g. fluid at 100 C from the pipe 38 from the economizer 46 in to the fluid inlet 13 and as much cooled fluid goes back to the economizer through the pipe 35.

As the next step the container is emptied, see FIG. 2. The bar feeder 22 draws the wall 20 to the left to open a possibility for the dried material to fall down. The bar feeder 11 pushes the wall 12 over the whole bottom 16 of the container and pushes out the dried material to the opening left after the moved wall. The dried material falls through the opening to any desired type of receiver. In the FIG. 2 the receiver is a conveyer 18 for transportation of the material 19 further. The material 19 can also fall directly in to a wagon or to another transportation device. The bar feeder scrapes then to the opening all the drying material which has fallen to the bottom 17 through the openings in the bottom 16.

The fan 8 is closed down during the discharge cycle and the heater 9 is cleaned by spraying cleaning water through the cleaning devise 7. The dirty cleaning water is discharged through the outlet 15 for water cleaning. When the cleaning cycle is finalized a new drying cycle is started.

When the cycle for discharging is finalized the walls 20 and 12 and the bar feeder 14 return to their original positions after which the feeding plate 1 is opened and the next charge of drying material 3 falls from the magazine 2 into the drying container and a new drying cycle starts.

Benefits of the Central Unit Compared with a Conventional Air Dryer.

Compared with conventional air dryers this system has the big advantage that the outgoing air is considerably warmer and its relative humidity is higher why the air flow out is considerably lower than from normal air dryers. Example:

| | Normal air | Circulation dryer, |
|---|---|---|
| | dryer | basic system |
| The temperature of the | 65 C. | 65 C. |
| heating media | | |
| The relative humidity of the | 75% | 95% |
| outgoing air | | |
| The temperature of the | 30 C. | 60 C. |
| outgoing air | | |
| Water content g/normal m3 | 25 | 150 |
| air | | |
| Lost air power kW/1000 kg/h | 548 kW | 160 kW |
| evaporated water at −10 C. | | |
| ambient temperature | | |
| Power for evaporation | 720 kW | 733 kW |
| kW/1000 kg/h water | | |
| Power need totally at −10 C. | 1268 kW | 893 kW |
| outdoor + evaporation | | |
| kW/1000 kg/h | | |

The basic system uses only about ⅙ of the air flow as a normal air dryer for the same evaporated water amount. This means a considerable energy saving during the winter, when outdoor air must be heated, although the air must be heated to 60 C instead of to 30 C.

The disadvantage of the system is that even in this case humid air with dust comes out into the surroundings.

3. System Without Dust Emission in to Atmosphere.

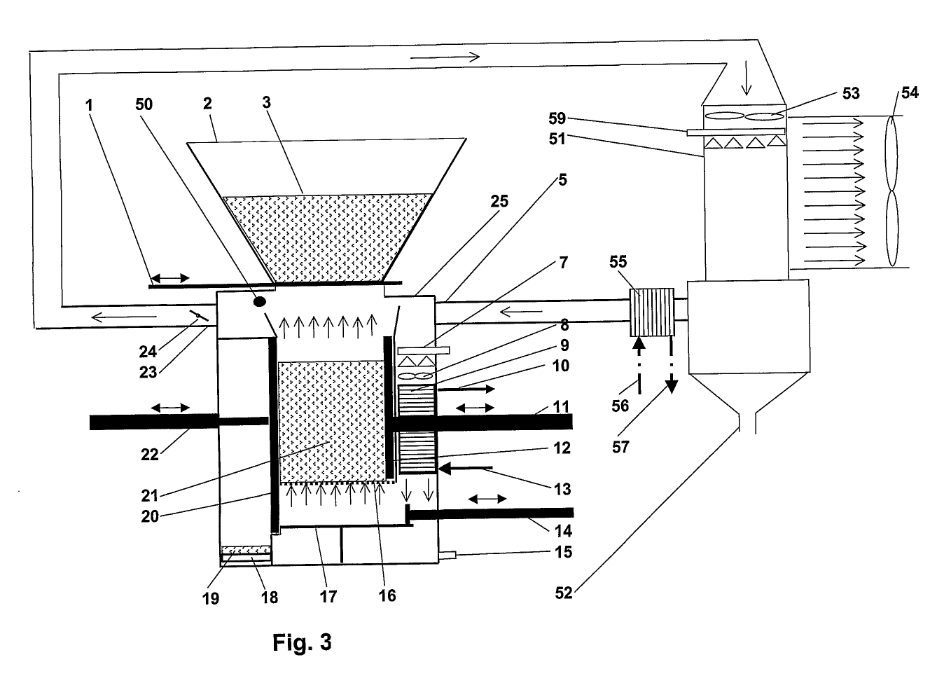

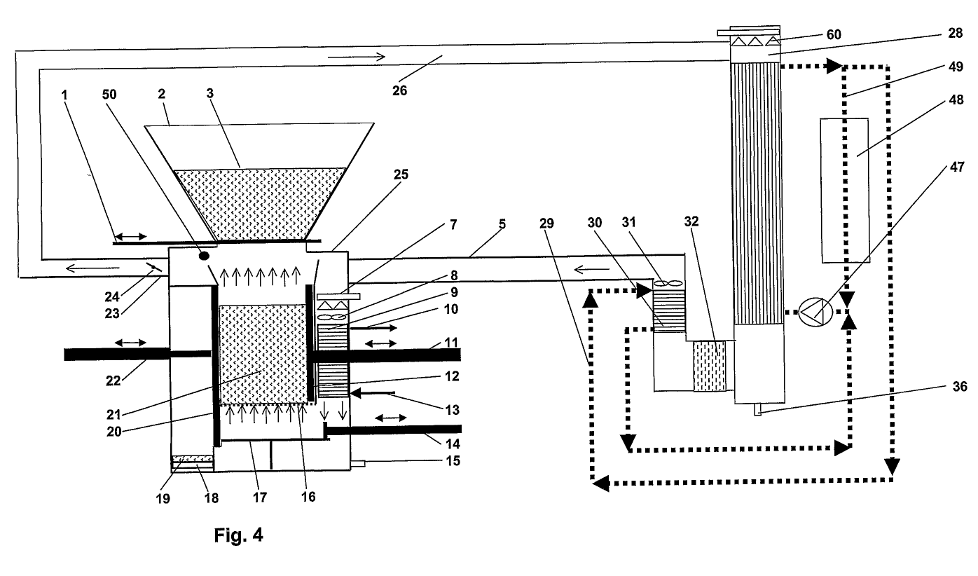

Emission of dust from the drying is eliminated through cooling the humid air after the channel 23 with a cooler. The air is dehumidified and the cold saturated air is led back to the central unit through the inlet channel 5. Examples for the cooling of the humid air are shown in the FIGS. 3 and 4. At the same time part of the remaining energy in the humid gas is used for something useful.

Cooling with an Out-Air Cooler with Collection of Condensate, FIG. 3.

The fan 53 sucks the warm humid air from the channel 23 and blows it through the air/air heat exchanger 51 of free design. The fan 54 sucks outdoor air through the other side of the heat exchanger. During the cooling water is condensated and is discharged through the outlet 52 in to a water cleaning system. If waste energy at any temperature is available the cooled saturated gas is preheated in the heat exchanger 55 with the waste energy via inlet 56 and outlet 57. If necessary the heat exchanger 55 has a cleaning device and a droplet separator with possibly a cleaning device before the heat exchanger. After the drying cycle is finalized the heat exchanger 51 is cleaned with the cleaning device 59. The heat exchanger 55 is also cleaned if necessary. The heated outdoor air can e.g. be used as a part of the combustion air in the combustion system 43 in the FIG. 7 or for heating of ventilation air.

Several parallel units are connected to the common air/air heat exchanger 51 by large drying need. With the dampers 24 and 6 every unit is disconnected from the system during the discharge and cleaning cycles.

Cooling with a Condenser, FIG. 4.

A condenser 28 takes the warm and humid air from the channel 26. The pump 47 pumps fluid through the condenser in a fluid circuit 29. The in the condenser heated fluid is used for heating any desired heat user 48, e.g. a green house, sport hall or ground with artificial grass as ice—and snow free sport/playing place in the winter. Part of the in the condenser recovered heat is used for preheating of the cold humid returning air to the channel 5 in the heat exchanger 30 after a droplet separator 32. Both the heat exchanger 30 and the droplet separator 32 have a cleaning device if necessary. The condenser 28 has a cleaning device 60. The fan 31 circulates the air in the system. All cleanings are done directly after the drying cycle is finalized.

Several units are connected in to the condenser 28 at high drying need. With the dampers 24 and 6 every unit is disconnected from the system during discharge and cleaning cycle.

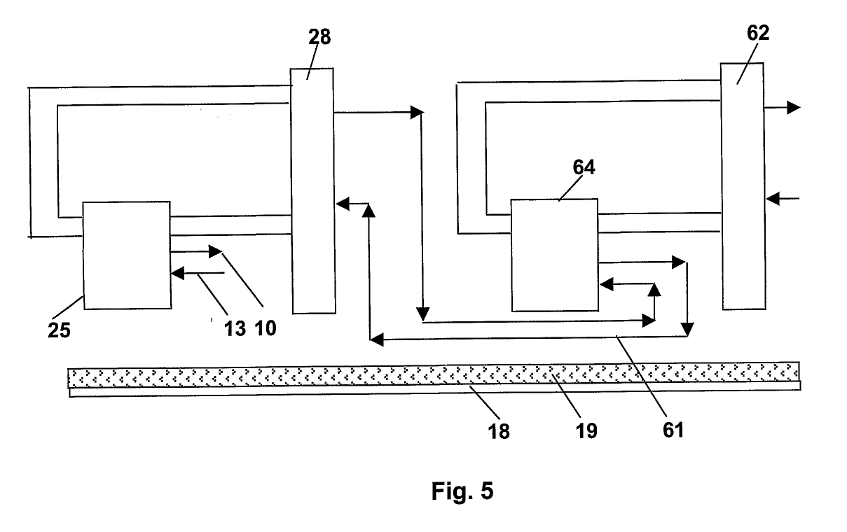

### Cascade System of Several Units, FIGS. 5 and 6.

In the system with cooling with a condenser a large part of the drying energy is recovered in the condenser, but at a lower temperature than the units heating fluid at the inlet 13. This heat can be used in drying units connected after the first unit into the system, so called cascade dryers. The first dryer is called the mother dryer; the units after it are called cascade dryers.

Because the cascade dryer works at a lower air temperature than the mother dryer because the condenser doesn't deliver as warm heating fluid as the fluid which via the inlet 13 heats the air into the mother dryer the cascade dryer works slower than the mother dryer. The cascade dryer needs also more air to be able to take care of the same water vapor. See the Help figure.

In the FIG. 6 a way is shown to get the cascade dryer to work the same way as the mother dryer. See even the FIG. 7. Hot fluid e. g. at 100 C from an economizer 46 is blended with in the condenser 28 heated fluid through the control valve 65 to increase the fluid temperature in to the drying stage 66 to the same temperature level as the ingoing heating fluid for the mother dryer 25. The same amount of fluid is then discharged back to the return pipe of the economizer 35. Every cascade dryer after the first uses consequently a large part of the waste energy from the cascade dryer before it and gets the rest heat from another heat source with a higher temperature than the ingoing fluid temperature in to the mother dryer.

The condensers need cold fluid as cooling fluid. A greenhouse or other profitable user of heat is used to cool the ingoing fluid, preferably protected against freezing, into the condenser. In the summer and during other times when the heat cannot be used it is dumped by an included outdoor- or water cooler.

The outgoing temperature of the heating fluid from the dryers varies during the drying cycle. At the beginning when a lot of water is evaporated the heating fluid is cooled strongly and can be used for cooling in the condenser 62. At the end of the cycle the heating fluid is not cooled at all. Therefore the control valve 70 controls continuously or stepwise the flow to the condenser 62 either directly from the dryer 66 or from the outlet of the heat receiver 48 so that the desired inlet temperature to the condenser 62 is reached.

Example of Additional Possibilities for optimizing of the Profitability, FIG. 7

In the FIG. 7 an example is shown between a boiler and the drying system with heat recovery possibilities.

Use of an Economizer in Boilers for Sawmills.

Boilers 43 in sawmills don't have for economical reasons normally an economizer installed after the boiler. Therefore it is profitable to install an economizer at the same time as the drying system is installed. The economizer gives extra high temperature heat at the magnitude of 6 to 8% to the normal sawmill operations. Part of this heat is also used to coordinate the function of the cascade dryers so that their drying capacity and drying time be the same as for the first dryer. It is also possible to get a safety margin for the dryness of the material by ending the drying cycle with a high temperature of the incoming heating water instead of the normally available waste heat.

Cleaning of Dust from the Drying System

The whole system uses cleaning of the components after the drying cycle to be sure that dust staying in the system is not disturbing its function. One additional way is to install an ionizer 67 before the condenser 58 and an ionizer 27 before the condenser 28. The dust particles are ionized with high voltage electricity. The condenser has in these cases lamella channels where the cooling fluid is pumped in contra flow in every second channel and the air in every second channel with about 10 mm free channel height for the air. The lamellas are earthed why the dust particles are drawn to the channels where the humidity in the air is condensed and spools down the particles with the water. This system can spool away even very small particles.

During the discharge cycle the drying material comes in contact with the outdoor air. A vacuum cleaner is used in the discharge system to separate the dust from the system.

Low Temperature Heat to e.g. Football Plan with Artificial Grass.

By using the patent 524 363 a part flow 40 from the return fluid to the flue gas condenser 58 can be used to give low temperature heating to any desired object 41 in FIG. 7. where the fluid is additionally cooled and recovers extra heat from the outgoing flue gas.

### The Most Important Benefits of the Innovation According to Point 3.

No outdoor air must be heated with a high energy loss as result.
No dust emissions into the atmosphere during the drying, only during the discharging when dust is leaving the dried material. This dust is sucked in a vacuum cleaner bag.
Low temperature heat can be used.
A considerable part of the driving heat is recovered and is used several times in cascade dryers coupled after the first unit.
The drying result is made sure through a short end drying at high temperature.

1-8. (canceled)

9. Method for drying material characterized by that heated gas or steam heated in a gas heater is led through the material to be dried in a closed vessel, is heated again in the gas heater and leads through the material so many times that the before specified relative humidity and temperature are reached before the gas heater after which part of the gas before the gas heater is directed to a cooling device for dehumidification and heat recovery to the cooling medium, after which the cold and dehumidified gas from the cooling device is directed to the inlet of the gas heater, the flow of the gas directed to the cooling device is so controlled that the relative humidity and temperature of the in the drier circulating gas is kept as desired why no emissions are slept out into the atmosphere.

10. Method according to the claim 9 characterized by that the cooling device is a gas/gas heat exchanger and the condensation heat is recovered in air for free use.

11. Method according to the claim 9 characterized by that the cooling device is a condenser and the condensation heat is recovered in the cooling fluid of the condenser for free use.

12. Method according to the claim 11 characterized by that the main part of the energy into the device is recovered in the heated cooling fluid of the condenser and is used once more for drying of material in a cascade dryer.

13. Method according to the claim 12 characterized by that the main part of the energy to the cascade-dryer is recovered in the condenser of that dryer and is used once more for drying of material in an additional cascade dryer.

14. Method according to the claim 11 characterized by that part of the in the condenser recovered heat is used to heat the cold and humid return gas from the condenser to the gas heater.

15. Method according to the claim 9 characterized by that additional heat is added to the heating system of the dryer for final drying of the material.
